(19) United States
(12) Patent Application Publication
(10) Pub. No.: US 2025/0072340 A1
(43) Pub. Date: Mar. 6, 2025

(54) MUSHROOM SUBSTRATE

(71) Applicant: Better Fresh Farms, Metter, GA (US)

(72) Inventors: Joseph L. BURKE, Statesboro, GA (US); Grant ANDERSON, Metter, GA (US)

(21) Appl. No.: 18/820,494

(22) Filed: Aug. 30, 2024

Related U.S. Application Data
(60) Provisional application No. 63/579,522, filed on Aug. 30, 2023.

(51) Int. Cl. A01G 18/22

(52) U.S. Cl. CPC A01G 18/22

(57) ABSTRACT

A mushroom substrate is formed from a composition including cotton gin waste and peanut shells.

### CROSS-REFERENCES TO RELATED APPLICATIONS

This application claims the benefit of U.S. Provisional Patent Application No. 63/579,522, filed Aug. 30, 2023, the entire contents of which are herein incorporated by reference.

### STATEMENT REGARDING FEDERALLY SPONSORED RESEARCH OR DEVELOPMENT

(Not Applicable)

### BACKGROUND

Mushroom substrate is a nutrient-rich organic material that allows mycelium to feed and flourish. Substrate is somewhat analogous to soil, but mushrooms are unable to photosynthesize their own food the way plants do, so additional nutrients are desirable. The mycelium spreads across the surface of the substrate like a tangled net. Introducing mycelium to substrate entwines them.

Mushroom fruiting bodies are comprised of up to 90 percent water, which they draw from the substrate. Properly hydrated substrate is important to fruitful harvests.

Existing substrates are typically made from a wide variety of organic materials, from animal manure to sawdust. Substrates may be formed from a mixture of several different ingredients. Currently, the material cost of growing mushrooms is expensive, with the majority of the materials coming from overseas markets such as China and Korea.

The shutdown of economies across the globe due to COVID-19 pandemic resulted in low production and growth, which resulted in stagnation in the mushroom substrate market. The demand for the healthier food and including the straw cereals in the food during the pandemic increased the demand for the mushroom substrate as people are inclined towards healthy foods and snacks. However, the lockdown during the COVID-19 resulted in low production and disruptions in supply chain of mushroom substrate market, further increasing the costs of production.

### SUMMARY

It would be desirable to derive a mushroom substrate using readily available materials including waste products from agricultural processes.

According to the described embodiments, mushroom substrate can be produced using local agricultural waste on which spawn can be added. Spawn is a nutritious material on which mycelium starts growing and then the mushroom starts colonizing on mushroom substrates. Use of mushroom substrate is also a regenerative way of cultivating mushrooms.

The significant rise in the demand for mushroom substrate in the foodservice industry, especially after the easing of lockdowns, has propelled the mushroom substrate market forward. The sale of the product has the potential to easily create a consumer base as the process of cultivation of mushrooms through substrate enables the cultivator to offer consistent and expected quantities and quality of mushrooms. The medicinal properties of mushroom substrate further bolster the market growth as because of these medicinal properties, the product finds application in the pharmaceutical sector, which has a high demand amidst the pandemic.

In an exemplary embodiment, a mushroom substrate is formed from a composition comprising cotton gin waste and peanut shells. The substrate may include 80% cotton gin waste, and/or at least one of pecan sawdust and olive press-cake. In some embodiments, the substrate includes 80% cotton gin waste, 10% peanut shells, 5% pecan sawdust, and 5% olive press-cake.

In another exemplary embodiment, a method of manufacturing a mushroom substrate includes the steps of (a) mixing cotton gin waste with additional ingredients; (b) pelletizing the mixed cotton gin waste and additional ingredients; and (c) forming the mushroom substrate into a log. Step (a) may include mixing the cotton gin waste with peanut shells. Step (a) may further include mixing the cotton gin waste with at least one of pecan sawdust and olive press-cake. press-cake.

### BRIEF DESCRIPTION OF THE DRAWINGS

These and other aspects and advantages will be described in detail with reference to the accompanying drawings, in which:

FIG. 1 is a flow diagram showing stages and processes in mushroom substrate production;

FIG. 2 lists the known equipment used for creating pelletized product that is subsequently used to create the mushroom logs, the equipment used for producing the substrate, and the equipment used for the biomass packing process;

FIG. 3 is a schematic representation of the pellet production line;

FIG. 4 shows an exemplary autoclave;

FIG. 5 shows the mushroom substrate after fruiting and prior to harvesting;

FIG. 6 shows exemplary fuel pellets created using agricultural waste;

FIG. 7 describes the use of cotton gin waste for soil/garden applications and for local farmers to supplement composting;

FIG. 8 describes uses of cotton gin waste for livestock feed;

FIG. 9 is a schematic illustration of an exemplary facility for processing cotton gin waste into mushroom substrate; and

FIG. 10 shows additional exemplary aspects of the compost facility, the tree nursery, and the dry storage facility.

### DETAILED DESCRIPTION

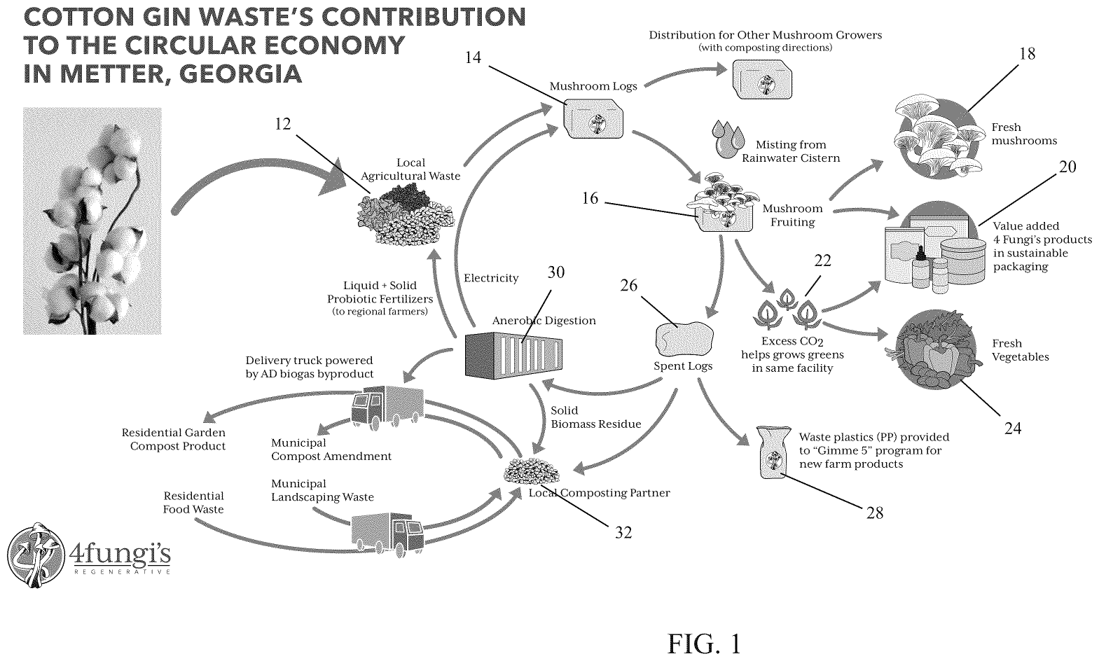

With reference to FIG. 1, local agricultural waste 12 such as cotton gin waste is pelletized and combined with additional materials to be formed into mushroom logs or blocks 14. In this process, it is desirable for the moisture content to not be too low or too high. A suitable moistness is 18% and the minimal level should be 12%. If the moisture content on the stalk is higher than recommended, a sawdust dryer will be used to dry the material, and if moisture content is less than the recommended 18%, then there is no need to go through the drying process. It is important that before the materials are pelletized the size of the material to be suitable. To crush the stalk into shorter particles, a hammer mill is efficient equipment that can be used for the grinding process.

With the recommended level of moisture in the raw material and the right size, the process of pelletization can take place. After the grinding and drying process, the pelletizing process begins with a series of known machines using a known process. After the material is pelletized, the resulting pellets are usually very hot and soft when they leave the pellet machine. Thus it is important to cool the pellets in a pellet cooler to strengthen and make the pellets durable for the market.

The agricultural waste pellets are then cooled and passed through a vibrating screen to remove fines. The fines can go through the pelletizing process again, and once screened they are ready to be packed and used.

The pellets are then processed into the mushroom logs.

### Step 1: Measure Out the Components

This recipe will make a block weighing approximately 4 lb 4 oz. The final bock should end up weighing 5 lbs after 12 oz of grain spawn is added. Multiple blocks can be assembled at a time, as many as can fit inside autoclave sterilizer.

### Step 2: Add Water to Pellets

Place cotton pecan pellets in a large tote for mixing. Add the correct amount of water and mix until the pellets have broken up into a loose sawdust texture.

### Step 3: Add Wheat Bran

Once the sawdust is mixed up and all the pellets are broken down, add the correct amount of olive waste making sure to mix the it thoroughly and evenly throughout the sawdust.

### Step 4: Add Mixture to Grow Bags

Weigh out the proper amount of mixture and add it to a grow bag. Add 4 lbs 4 oz to each grow bag, which makes a 5 lb block once the spawn is added. The bags are specially made for growing mushrooms. They are made of polypropylene, which can withstand the sterilization process. The Filter patch allows the mushrooms to breath while they are colonizing the substrate.

### Step 5: Fold the Bags Down

The tops of the grow bags are gusseted and folded down in a specific way, with a filter fitted in between the gussets. This prevents contamination during cooldown after sterilization. When the bags cool down, air will be drawn into the bags.

### Step 6: Pressure Sterilize

As discussed in more detail below, an autoclave is loaded with the bags stacked on top of each other. The grow bags should be prevented from making direct contact with the bottom of the sterilizer, as this could cause the bags to burn. Fill with the water to just below the top of the bottom bag. Pressure sterilize the bags for 2.5 hours. A fruiting block post-sterilization is ready to be inoculated with grain spawn. The filter patch is slipped in between the gussets and the top is folded over twice.

### Step 7: Cool Down and Inoculation

Allow the autoclave to fully cool down over night. Anything over 38 degrees C. can potentially kill the mycelium. Fruiting blocks are inoculated in front of a laminar flow hood. Once grain spawn is added to the block, tie off the top of the bag with a piece zip tie and set on a shelf. Shake the bag to evenly distribute the individual grains throughout the bag. This will speed colonization of the block.

Spawn for a particular variety of mushroom is applied to the mushroom logs 14. This step of the process involves bringing the spawn into contact with the substrate to initiate its growth and development. In some embodiments, the method has the substrate inoculated in a sterile space to avoid contaminating the substrate. A commercial lab may include a separate space for lab use, cleaning and maintaining that space, using HEPA (high efficiency particulate air) filters, and equipment for steam treatment and being mindful of the “seven vectors of contamination” and implementing proper lab technique. Inoculation rates are a balance between economics and speed of spawn run. At this stage, we are trying to get the desired edible mushroom mycelium established before anything else. The higher the inoculation rate or amount of spawn added to the substrate, the faster the mycelium will grow through the substrate.

The mushroom logs 14 may be shipped to other growers prior to the application of spawn so that the other growers can apply their preferred variety of mushroom. Alternatively, the mushroom logs 14 can be shipped to other growers after inoculation with a particular mushroom variety spawn.

After misting from rainwater cisterns or the like, the mushroom spawn go through an incubation process. After inoculation, the spawn needs time to grow through the substrate. Incubation starts with leap off, which is the moment when the mycelium initially leaps off the spawn onto the new substrate. This typically occurs around four days after inoculation. The mycelium expands through the substrate in a three dimensional sphere. When the mycelium runs into another leap-off point, the mycelium fuse together until the entire substrate becomes one mycelial organism. When the mycelium has grown throughout all of the available food, full colonization has been achieved and they can now be initiated into fruiting 16.

Initiation is the link between mycelial growth and mushroom formation. This is the time when the substrate is fully colonized and maybe even showing signs of pinning. The mushroom substrate is moved to a location that encourages growth. To initiate fruiting, lowering temperatures and increasing oxygen levels generally encourage mushroom formation. Initiation can be in the form of cold shocking, water shocking or introducing more oxygen by cutting a hole in the bag.

The fruiting process is as much an art as it is a science. Direct observation of the mushrooms and substrate is needed throughout the fruiting process and for each crop. The mushrooms, in their morphology, color, texture, and abundance communicate what it is they need during the fruiting process.

After fruiting, fresh mushrooms 18 can be harvested for sale into a culinary market. Alternatively or additionally, the mushrooms 20 can be dried via freeze drying or some other drying process or the mushrooms can be “powdered” for sale into a secondary market as a retail product or as an ingredient in other products in which the mushrooms can be used.

Excess CO₂ 22 can be harvested and funneled into green production for applications to other vegetable farming 24 or in combination with the dried mushrooms 20.

After harvesting the mushrooms, spent logs 26 can be processed to move any plastic portions that are unable to be processed organically through a recycling program 28. The spent logs 26 can be processed via anaerobic digestion 30 into a liquid probiotic fertilizer, which can go back to a local composting partner 32 or applied to the existing local agricultural waste store 12. The supplemented waste can be used by farmers for nutritional supplementation or other field applications. Alternatively, the spent logs 26 can be applied directly to the local composting partner 32 if anaerobic digestion is not required.

The liquid probiotic fertilizer can also go through a biodigestion process to create biodiesel to help fuel local delivery trucks.

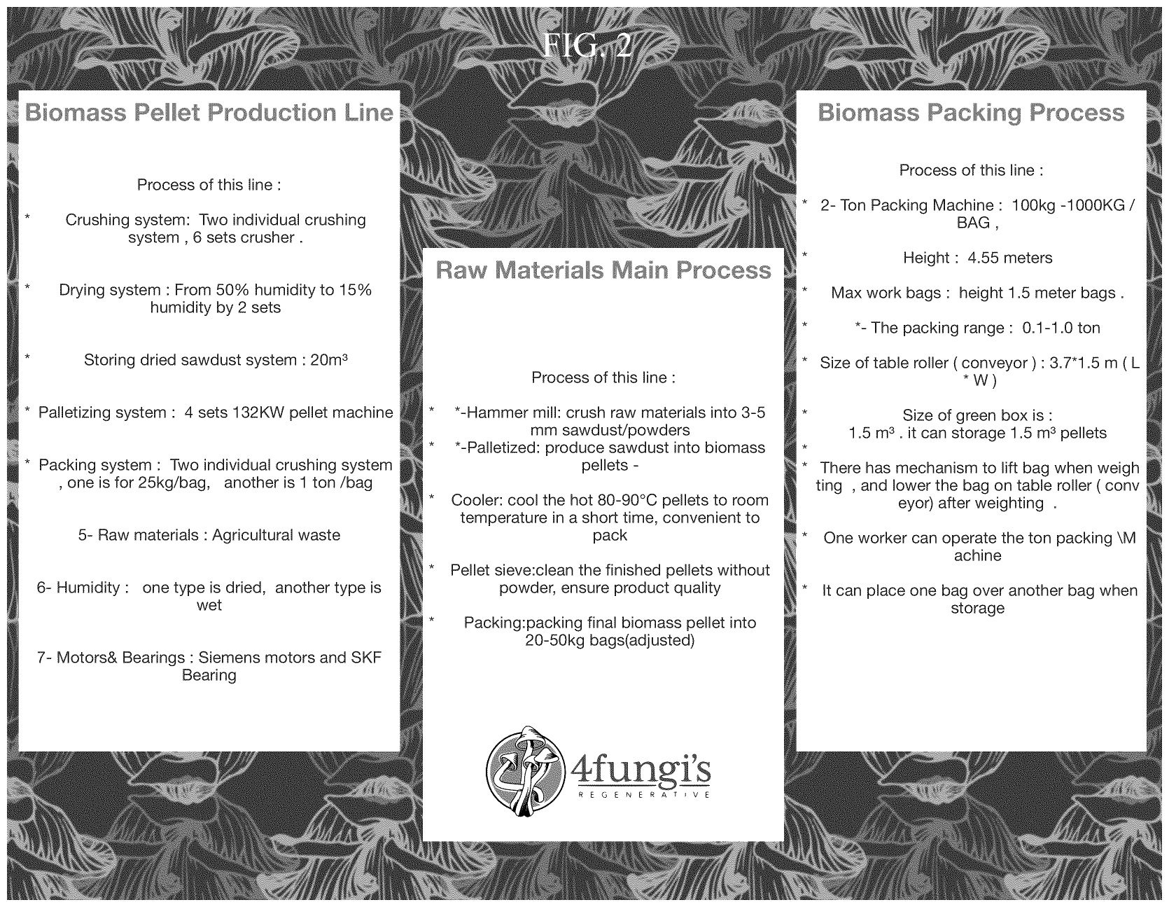

FIG. 2 lists the known equipment used for creating pelletized product that is subsequently used to create the mushroom logs, the equipment used for producing the substrate, and the equipment used for the biomass packing process.

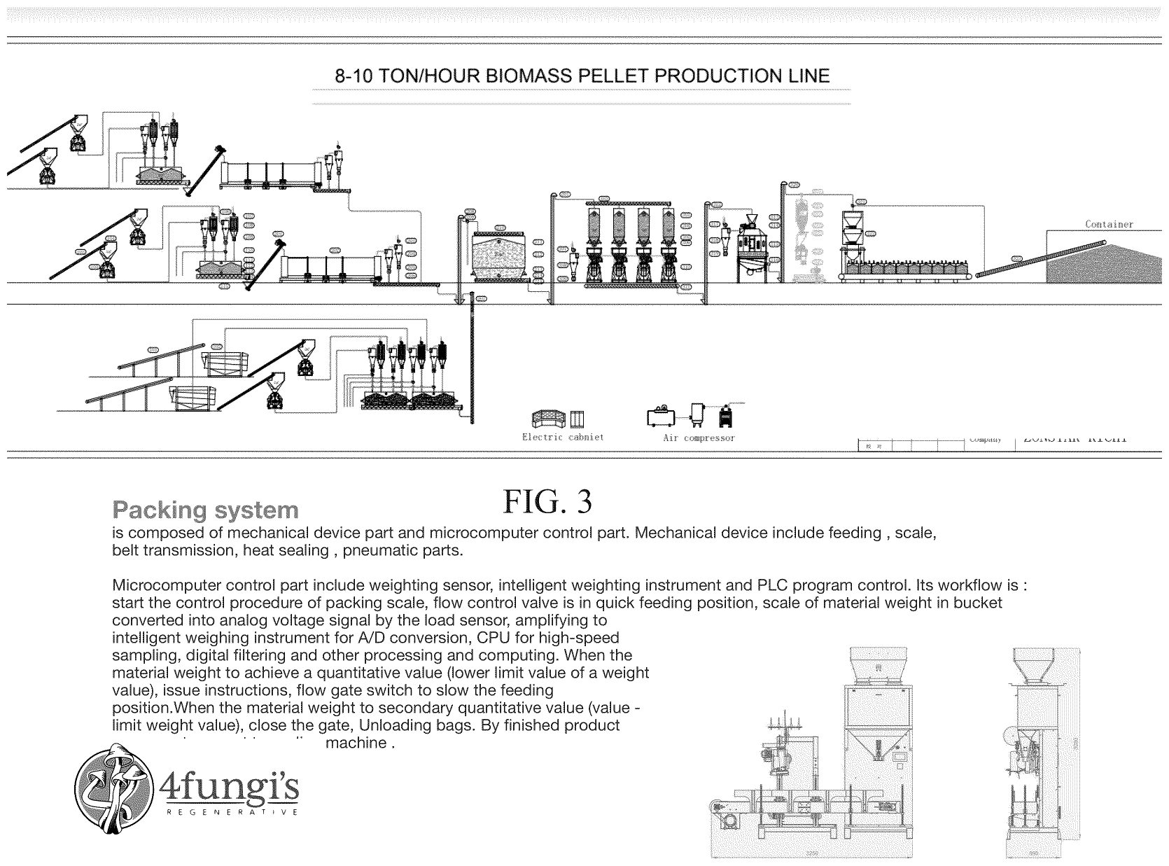

FIG. 3 is a schematic representation of the pellet production line. The cotton gin waste goes through a series of grinders and sorters to remove debris that is not ground to the appropriate size. The material is then compressed into the appropriately sized pellets, and the pellets are processed through a packaging system for bulk containment or smaller portions for retail sale. The packing system is composed of a mechanical device part and a microcomputer control part. The mechanical device includes feeding, scale, belt transmission, heat sealing, and pneumatic parts. The microcomputer control part includes weighting sensor, intelligent weighting instrument, and PLC program control.

When discharging from the pallet making machine, the temperature of the pellets is around 80˜90° C. The structure is relatively loose and easy to be broken. Through a counter flow cooling system, the pellets are cooled to room temperature and become tight and durable. Then, the pellets can be packaged in bags or be conveyed to storage silo. For bagging, the mixed pellet material are fed to the open mouth bagging machine by an overhead supply hopper. The operator places an empty bag on the filling machine. When the bag achieves a preset target fill weight, the machine releases the filled bag onto the bag closing conveyor. Next, the operator moves the bag through a heat sealer.

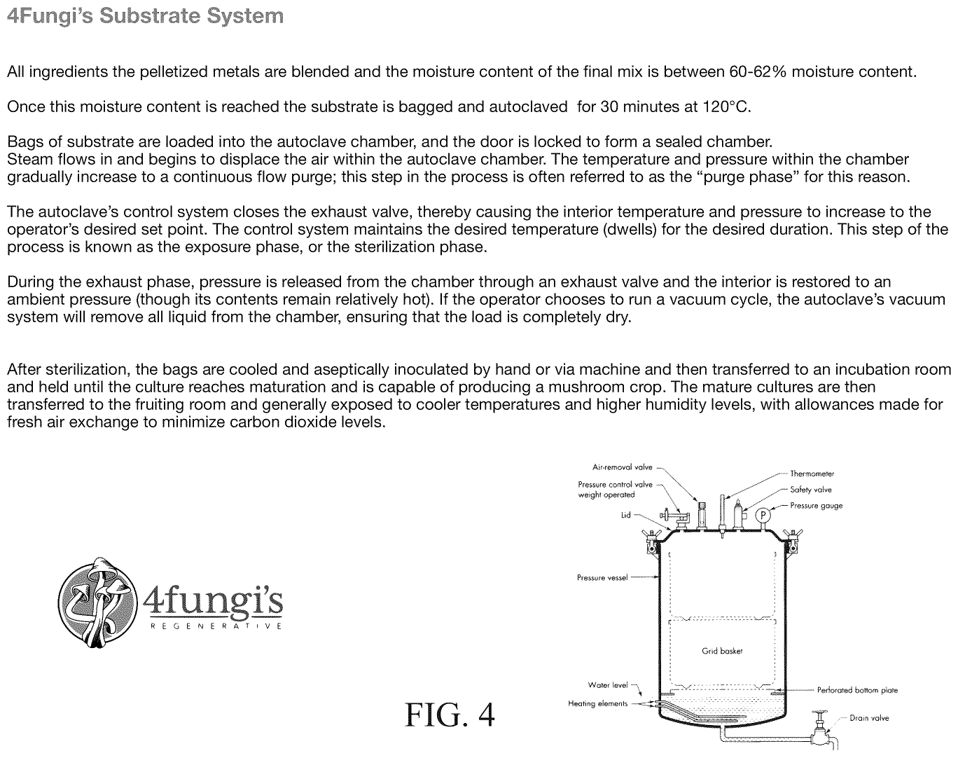

For mushroom production, it is important to sanitize the material. This is significant for food safety purpose and to ensure that mushrooms to be cultivated in that environment are the only biological presence in that material (i.e., without any other bacterial presence or microbial existence that can disturb the mushrooms being grown in that material). FIG. 4 shows an exemplary autoclave for this purpose. All ingredients for the pelletized materials are blended, and the moisture content of the final mix is between 60-62% moisture content. The ingredients may be blended using a ribbon blender that typically consists of a U-shaped horizontal trough and a solid agitator shaft mounted with spokes that support outer and inner helical blades (called “ribbons”).

Once this moisture content is reached, the substrate is bagged and autoclaved for 30 minutes at 120° C. Bags of substrate are loaded into the autoclave chamber, and the door is locked to form a sealed chamber. Steam flows in and begins to displace the air within the autoclave chamber. The temperature and pressure within the chamber gradually increase to a continuous flow purge (this step in the process is often referred to as the “purge phase” for this reason). The autoclave's control system closes the exhaust valve, thereby causing the interior temperature and pressure to increase to the desired set point. The control system maintains the desired temperature (dwells) for the desired duration. This step of the process is known as the exposure phase, or the sterilization phase.

During an exhaust phase, pressure is released from the chamber through an exhaust valve, and the interior is restored to an ambient pressure (though its contents remain relatively hot). If the operator chooses to run a vacuum cycle, the autoclave's vacuum system will remove all liquid from the chamber, ensuring that the load is completely dry.

After sterilization, the bags are cooled and aseptically inoculated by hand or via machine and then transferred to an incubation room and held until the culture reaches maturation and is capable of producing a mushroom crop. The mature cultures are then transferred to a fruiting room and are generally exposed to cooler temperatures and higher humidity levels, with allowances made for fresh air exchange to minimize carbon dioxide levels.

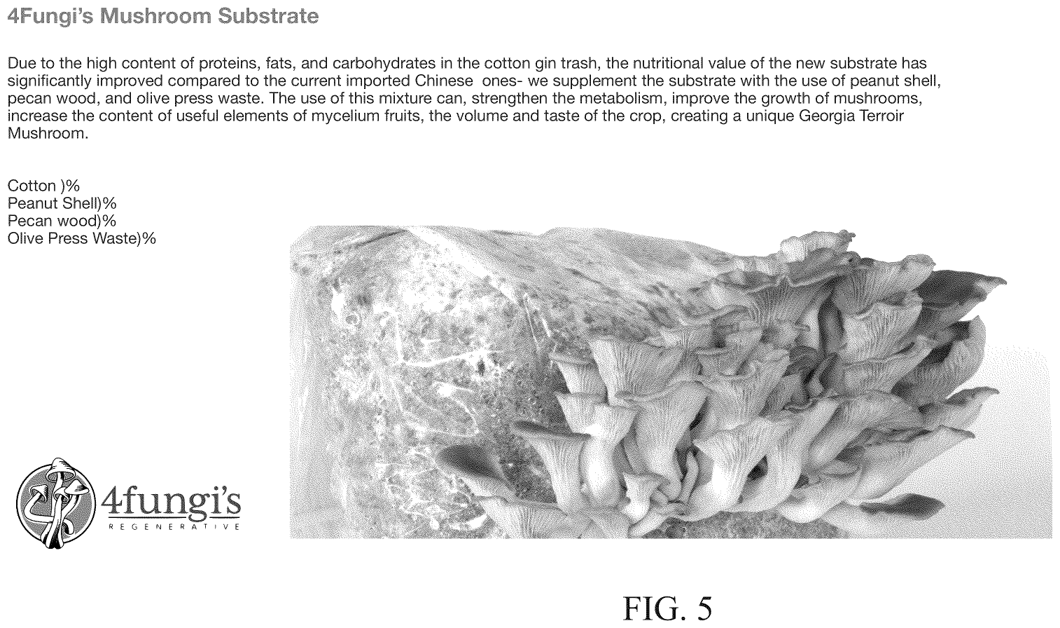

FIG. 5 shows the mushroom substrate after fruiting and prior to harvesting. Due to the high content of proteins, fats, and carbohydrates in the cotton gin waste, the nutritional value of the mushroom substrate has significantly improved compared to existing substrate materials. Materials added may include peanut shell, pecan wood, and olive press waste (i.e., olive press-cake). The use of this mixture can strengthen the metabolism, improve the growth of mushrooms, increase the content of useful elements of mycelium fruits, increase the volume and taste of the crop, among other advantages.

In an exemplary embodiment, the materials may include 80% cotton gin waste, 10% peanut shells, 5% pecan sawdust, and 5% olive press-cake. These values are variable depending on the mushroom type intended for growth and processing. Ingredient ranges can vary by mushroom variety from as little as 60% cotton gin waste. Lower percentages of cotton gin waste will affect mushroom yield. Also, some varieties may not require the pecan sawdust of the olive press-cake. For example, the materials may include 85% cotton gin waste and 15% peanut shells. In some embodiments, the cotton gin waste and the peanut shells define the primary components, and use of the pecan sawdust and olive press-cake may be varied depending on mushroom variety.

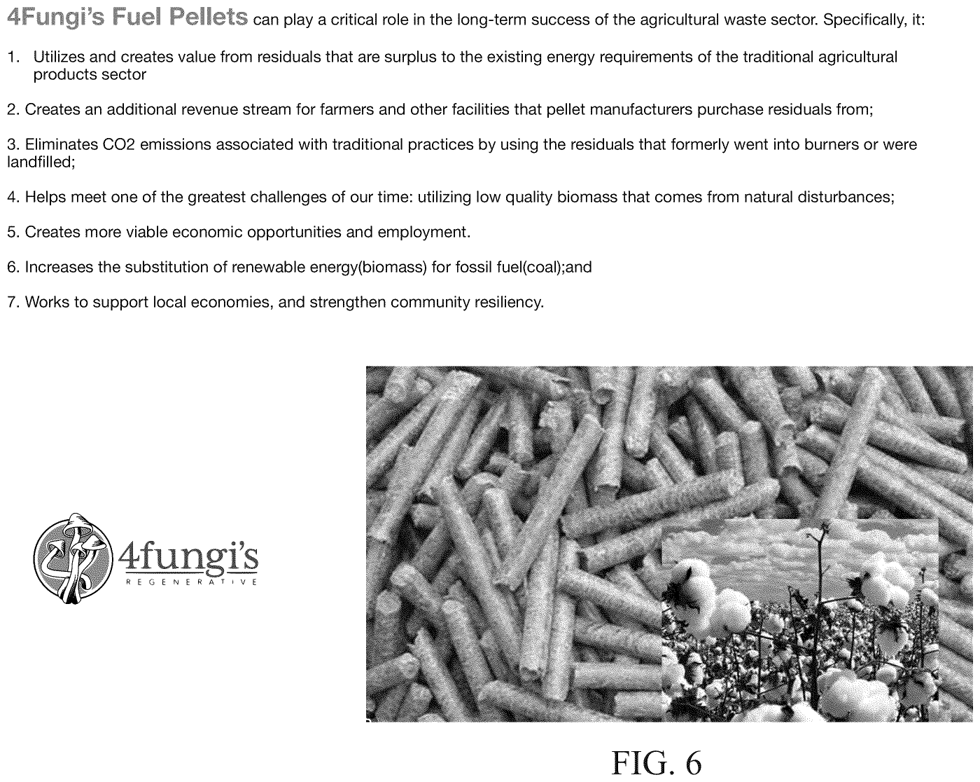

FIG. 6 shows exemplary fuel pellets created using agricultural waste. The fuel pellets can play a critical role in the long-term success of the agricultural waste sector. The product utilizes and creates value from residuals that are surplus to the existing energy requirements of the traditional agricultural products sector. Additionally, the product creates an additional revenue stream for farmers and other facilities that pellet manufacturers purchase residuals from and eliminates CO₂ emissions associated with traditional practices by using the residuals that formerly went into burners or were landfilled. The product utilizes low quality biomass that comes from natural disturbances and creates more viable economic opportunities and employment. The fuel pellets can increase the substitution of renewable energy (biomass) for fossil fuel (coal), and overall, the process works to support local economies and strengthen community resiliency.

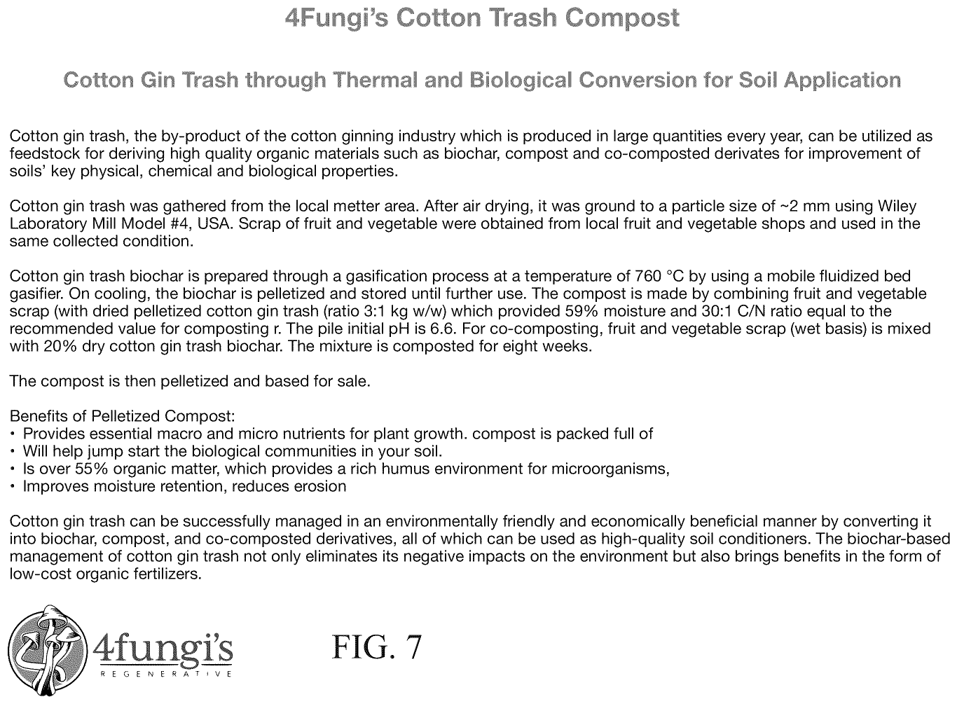

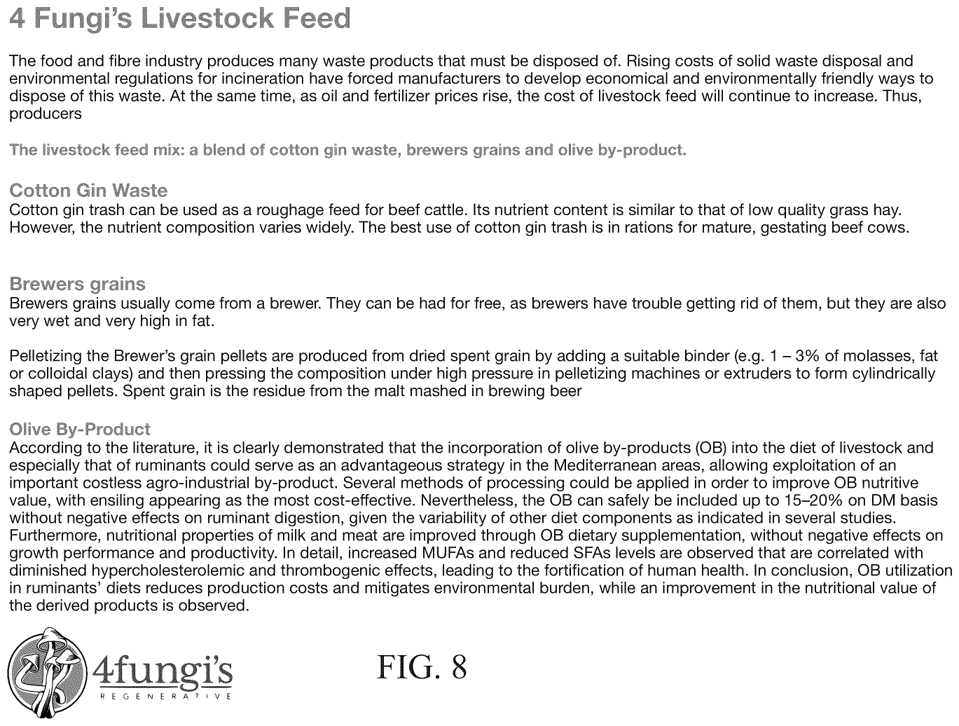

FIG. 7 describes the use of cotton gin waste for soil/garden applications and for local farmers to supplement composting. FIG. 8 describes uses of cotton gin waste for livestock feed. The composition of the cotton gin waste along with brewers grains and olive by-products can add nutritional value for livestock feed.

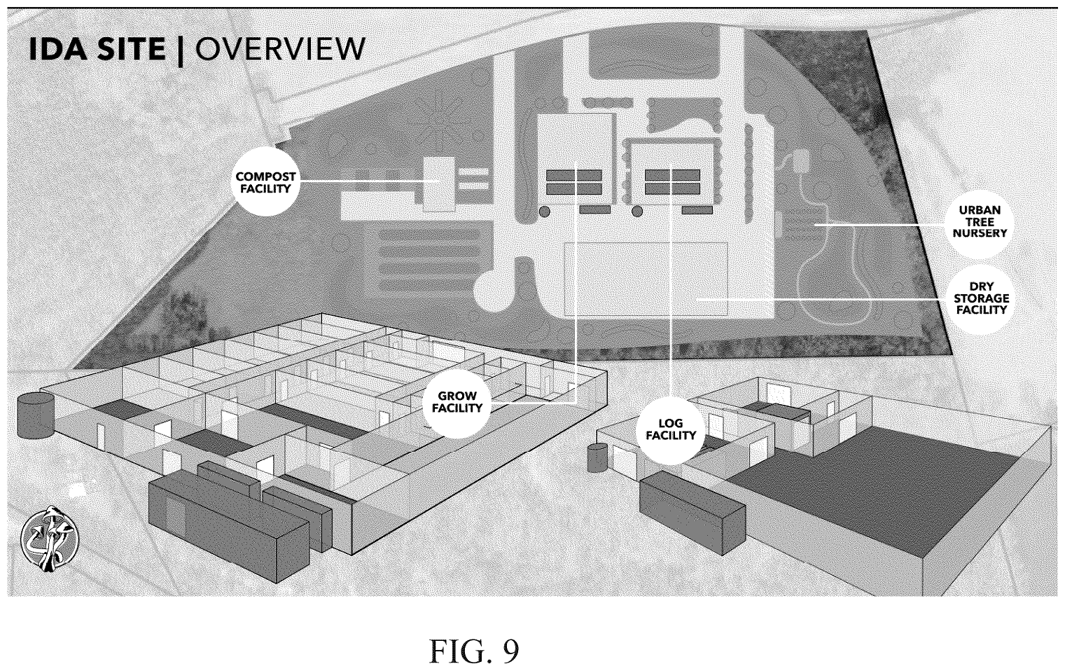

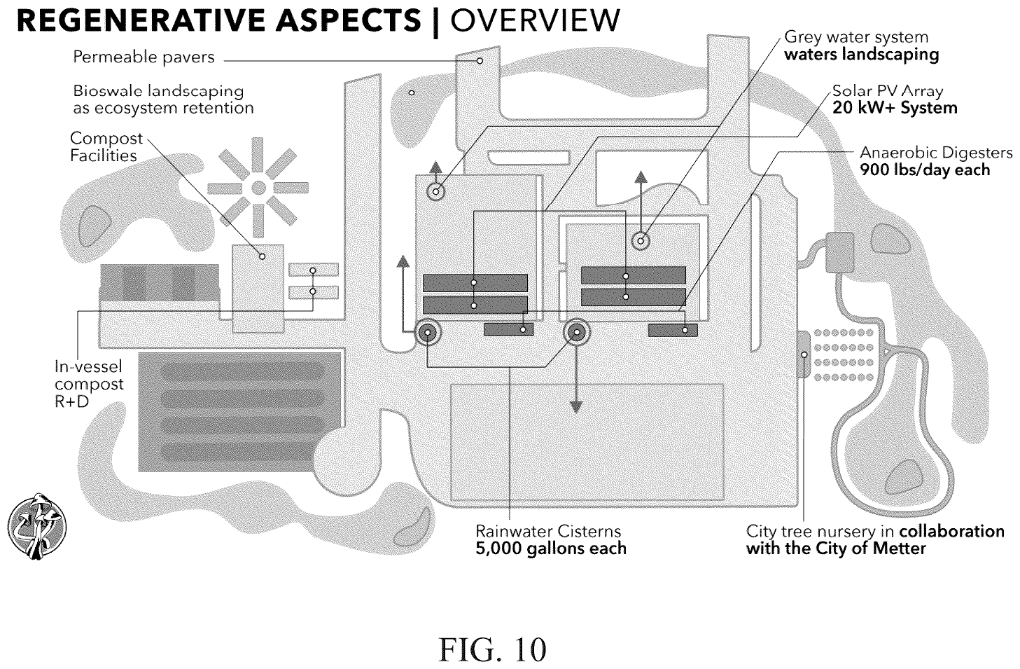

FIG. 9 is a schematic illustration of an exemplary facility for processing cotton gin waste into mushroom substrate. FIG. 10 shows additional exemplary aspects of the compost facility, the tree nursery, and the dry storage facility.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A mushroom substrate formed from a composition comprising cotton gin waste and peanut shells.

2. A mushroom substrate according to claim 1, comprising 80% cotton gin waste.

3. A mushroom substrate according to claim 1, further comprising at least one of pecan sawdust and olive press-cake.

4. A mushroom substrate according to claim 3, comprising 80% cotton gin waste, 10% peanut shells, 5% pecan sawdust, and 5% olive press-cake.

5. A method of manufacturing a mushroom substrate comprising:
(a) mixing cotton gin waste with additional ingredients;
(b) pelletizing the mixed cotton gin waste and additional ingredients; and
(c) forming the mushroom substrate into a log.

6. A method according to claim 5, wherein step (a) comprises mixing the cotton gin waste with peanut shells.

7. A method according to claim 6, wherein step (a) further comprises mixing the cotton gin waste with at least one of pecan sawdust and olive press-cake.
